(19) United States
(12) Patent Application Publication
(10) Pub. No.: US 2007/0228734 A1
(43) Pub. Date: Oct. 4, 2007

(54) Inductive device actuated by body motion

(76) Inventor: Sten R. Gerfast, Mendota Heights, MN (US)

Correspondence Address: Mr. Sten Gerfast, 1802 Valley Curve Rd., Mendota Heights, MN, 55118, US

(21) Appl. No.: 11/396,088

(22) Filed: Apr. 3, 2006

(51) Int. Cl. H02K 7/18; F03G 7/08; F02B 63/04

(52) U.S. Cl. 290/1 R

(57) ABSTRACT

A human motion-powered induction device that is able to keep the battery charged in cell phones, music players and other mobile electronic equipment.

### BACKGROUND OF THE INVENTION

This invention concerns the generation of a charge current for a battery or other electrical or electronic apparatus. More specifically it concerns an inductive device that is “worn” or located in close proximity to a moving person. When the person moves, even a minute movement, causes a magnet to move inside a coil and the induction between the magnet and the coil generates a current that is useful for keeping battery charged.

It is characterized by its low friction, has a low weight frame and also has a very simple construction.

### DESCRIPTION OF RELATED ART

Batteries for cell-phones, portable phones, music players or other electrical or electronic products are normally re-charged at an electrical outlet or at an outlet in a car or truck using a “plug-in” charger.

This provides a somewhat convenient way of retaining the charge of the battery. The disadvantage is of course to remember to bring it, and to plug it in before the battery is too far discharged to be useful. Flashlights have, in the past, been constructed to provide light without batteries by moving a hand-operated lever, or vigorously shaking the flashlight. A battery or capacitor inside the flashlight extends the useable time until discharge.

### SUMMARY OF THE PRESENT INVENTION

It is the object of the present invention to keep the battery always in a charged state by using the “normal” body motion of a person moving, walking, running, exercising or riding in or on a transport equipment to move a magnet located in a close relationship to a coil.

The movement of the magnet next to an induction coil induces current at the rate of either a reciprocating magnet or a rotating magnet. The higher rate, or speed, of the magnets mechanical motion, the higher the current. The human body can best be used to generate a current with a reciprocating motion that occurs “normally” when the body is in motion, (walking, running, exercising) or the moving and swaying when the body is riding in any form of transport equipment. The motion of the magnet also occurs when it is mounted in a carriage with wheels. The relative body motion of many parts of a human being, or of an animal body, such as feet and limbs can be used to move the above-mentioned magnet. With respect to a person moving, walking or running there are many placement of a magnet that would constitute reciprocating motion.

The magnet/coil device could also be put in a pocket or in a container, such as a cell phone carrier, were two electrical contacts could be used to charge the battery inside the cell phone or similar device.

When the magnet/coil devise is carried by or attached to a person that is walking, said pocket or container is doing an undulating or reciprocating motion that moves the magnet.

A magnet in close relationship to a coil of wire, with the magnet reciprocating in the front of the coil, generates an AC or alternating current. Charging a battery requires a DC or direct current that can be produced from the AC by rectification using a diode or a diode bridge.

The alternating current, without rectification, can be used to light a small incandescent lamp that can be used as a “to-be-seen-in-dark” lamp. With rectification is can be used for the same purpose lighting up an LED (light emitting diode). The moving body of a person or animal provides the magnet motion. The magnet/coil devise, of the present invention, can be made in different embodiments.

A short cubic or rectangular “box-shape magnet” sliding inside a rectangular “tunnel-like” coil-form made from magnet-wire, would induce current into the wire when the magnet would slide back and forth.

See FIG. 2 The magnet would be magnetized front to back with a North pole on one side and a South pole on the other side, with these poles in close proximity to the “walls” of the tunnel were both poles generate current.

The magnet material can be selected from Alnico, Ferrite, Neodymium or samarium-cobalt.

The inductive coil, shaped like a tunnel, is fabricated from magnet wire and with individual strands held together with material selected from varnish, solvent or heat fusing.

To minimize friction, in all of the embodiments described herein, a coating or lining can be applied.

The lining material is selected from teflon, acetal or nylon.

The induced currents that appear at the ends of the magnet wires can be connected to a load such a battery.

The magnets also could be made from two sections with a pivoted wheel in the center achieving rolling friction instead of the above-described sliding friction. Both penduling, pivoting and back and forth motion is providing very low friction. It is preferable to mount the magnets on a ferromagnetic material to provide “back-iron” See FIG. 3. A second embodiment would be to make the “tunnel” with a curvature and the magnet suspended as a pendulum, with the pendulum's arc and pivot point co-inciding with the tunnel curvature. This pivoted assembly would substantially decrease the friction. See FIG. 1. With this construction the magnet would have to be magnetized radially. A third embodiment would be to make the “tunnel” with a circular cross section, and also make the magnet cylindrical, with the magnet sliding inside the cylindrical tunnel.

If an cylindrical magnet would be journalled on a center post and reciprocate without touching it would have a minimal amount of friction. The magnet is then supported by a center rod and being easily set in reciprocating or vibrating motion. See fig.4. With this construction the magnet would also have to be magnetized radially. Combinations of these embodiments can also be made by a person skilled in the art.

Another object of the present invention is to make the magnet/coil assembly small, light and easy to produce The reciprocating motions of the magnets are normally sufficient to keep a battery that does not have a heavy load charged at all times. Or supplying current to a lamp or LED.

It could be described as an inductive devise actuated by body motion comprising:

a frame mounted multi-turn inductive coil having an curved, open internal diameter,

a pivoted magnet assembly pivoting inside said curved internal diameter,

said frame carried by or attached to a human body,

when said body is in motion said magnet assembly pivots inside said coil,

inducing an AC current in said coil, said AC current rectified and further connected to a battery,

wherein said rectified current is providing charge current to said battery.

Another way to describe this novel design is as an inductive devise actuated by body motion comprising:

a frame mounted multi-turn inductive coil having an open internal cross-section,

a magnet assembly sliding inside said internal cross-section,

said frame carried by or attached to a human body,

when said body is in motion said magnet assembly slides inside said coil,

inducing an AC current in said coil, said AC current rectified and further connected to a battery, wherein said rectified current is providing charge current to said battery.

Another way to describe this novel design is as an inductive devise actuated by motion comprising:

a frame mounted multi-turn inductive coil having an open internal cross-section,

a magnet assembly sliding or moving inside said internal cross-section,

said frame carried by or attached to a reciprocating or vibrating body,

when said body is in motion said magnet assembly slides/moves inside said coil,

inducing an AC current in said coil.

A person skilled in the art could easily make other combinations of the above described designs.

### BRIEF DESCRIPTION OF THE DRAWINGS

FIG. 1 shows a frame mounted coil and pivoted magnet assembly.

FIG. 2 is showing a tunnel with a sliding magnet assembly.

FIG. 3 is section of a rectangular coil with a non-touching magnet journalled on a rotating wheel.

FIG. 4 is showing a cylindrical magnet assembly inside a cylindrical coil.

### DETAILED DESCRIPTION OF THE DRAWINGS.

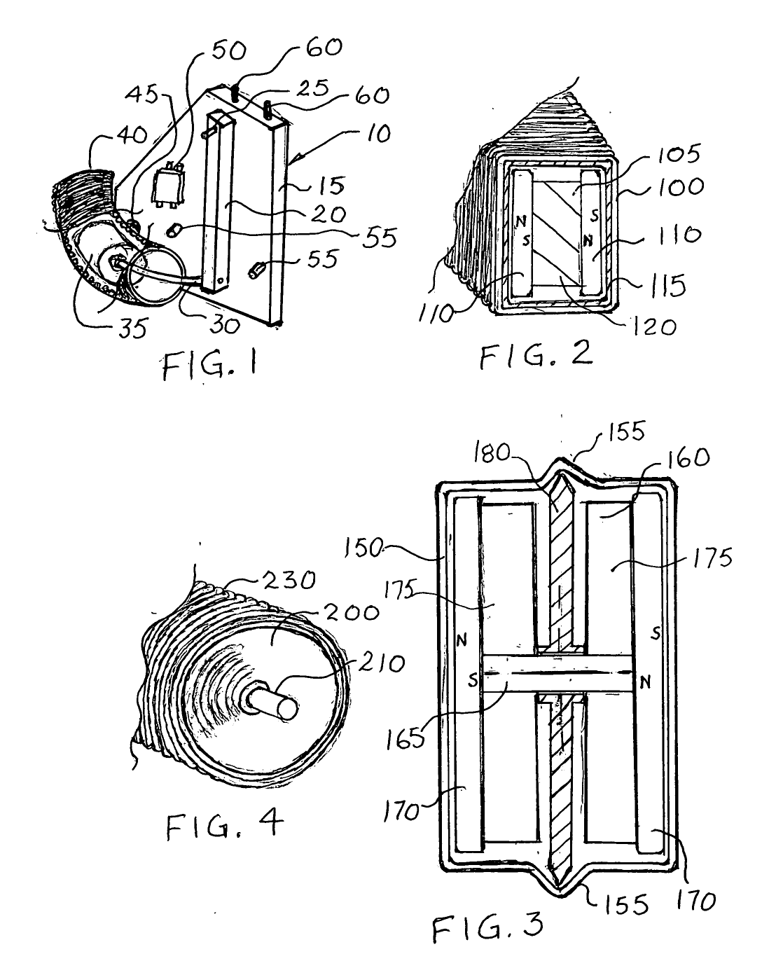

In FIG. 1 the inductive device 10 is having a frame 15, with a pivoted arm 20, a pivot point 25.

The arm 20 is connected to a curved arm 30 attached to a curved magnet 35 inside a multi-turn coil 40, mounted at 45 to said frame 15. Also shown is a diode or diode bridge 50 and two mechanical stops 55.

Two electrical charge current connectors 60 are also shown

In FIG. 2 is showing a rectangular multi-turn coil 100 and a sliding magnet assembly 105 that consists of two magnets 110. A coating or liner 115 is also shown on the inside of the coil 100.

FIG. 3 is showing a cross-section of a rectangular coil 150 having two formed ridges 155 and a magnet assembly 160 having an internal wheel pivoted on a shaft 165. The magnet assembly 160 is composed of two magnets 170 and two ferromagnetic parts 170 that are both free to move without touching.

FIG. 4 is showing a cylindrical magnet 200 slidably journalled on a shaft 210 inside a coil 230.

1. An inductive devise actuated by body motion comprising:
a frame mounted multi-turn inductive coil having an curved, open internal diameter,
a pivoted magnet assembly pivoting inside said curved internal diameter,
said frame carried by or attached to a human body,
when said body is in motion said magnet assembly pivots inside said coil,
inducing an AC current in said coil, said AC current rectified and further connected to a battery,
wherein said rectified current is providing charge current to said battery.

2. An inductive devise as defined in claim 1 wherein said battery is mounted in a mobile electronic equipment and said equipment is connected to said inductive device.

3. An inductive devise as defined in claim 1 wherein said frame is carried by or attached to an animal body.

4. An inductive devise as defined in claim 1 wherein said coil's internal opening has a rectangular cross section.

5. An inductive devise actuated by body motion comprising:
a frame mounted multi-turn inductive coil having an open internal cross-section,
a magnet assembly sliding inside said internal cross-section,
said frame carried by or attached to a human body,
when said body is in motion said magnet assembly slides inside said coil,
inducing an AC current in said coil, said AC current rectified and further connected to a battery,
wherein said rectified current is providing charge current to said battery.

6. An inductive devise as defined in claim 5 wherein said coil's internal cross-section is substantially rectangular wherein said magnet assembly is dual with a central anti-friction wheel riding in said rectangular cross-section.

7. An inductive devise actuated by motion comprising:
a frame mounted multi-turn inductive coil having an open internal cross-section,
a magnet assembly sliding or moving inside said internal cross-section,
said frame carried by or attached to a reciprocating or vibrating body,
when said body is in motion said magnet assembly slides/moves inside said coil,
inducing an AC current in said coil.

8. An inductive devise as defined in claim 1 wherein said battery is mounted inside said frame and further having an LED connected to said battery.

9. An inductive devise as defined in claim 1 wherein said magnet assembly is magnetized radially.

10. An inductive devise as defined in claim 7 wherein said frame is carried by or attached to a body when walking, running, exercising or riding in or on transport equipment.

11. An inductive devise as defined in claim 10 wherein said transport equipment is on wheels.

12. An inductive devise as defined in claim 1 wherein said coils individual strands are held together by materials selected from varnish, solvent or heat fusing.

13. An inductive devise as defined in claim 1 wherein said coil has an inside coating or liner made from a material selected from teflon, acetal, or nylon.

14. An inductive devise as defined in claim 1 wherein said frame has electrical connections that are suitable for connection to a cell phone inside its pocket carrier or inside other electronic equipment carriers.

15. An inductive devise as defined in claim 1 wherein said AC current is connected to a rectifier.
